(19) United States
(12) Patent Application Publication
(10) Pub. No.: US 2003/0046116 A1
(43) Pub. Date: Mar. 6, 2003

(54) Dental insurance eligibility determination and utilization recordation system

(76) Inventors: Fred L. Horowitz, Chicago, IL (US); Randall Kriz, Ingleside, IL (US)

Correspondence Address: Max Shaftal, PATZIK, FRANK & SAMOTNY LTD., Suite 900, 150 South Wacker Drive, Chicago, IL, 60606, US

(21) Appl. No.: 10/273,711

(22) Filed: Oct. 18, 2002

Related U.S. Application Data
(63) Continuation of application No. 09/288,757, filed on Apr. 8, 1999.

(51) Int. Cl. G06F 17/60

(52) U.S. Cl. 705/4

(57) ABSTRACT

A system for determining benefit eligibility of a patient/participant in a dental plan by a dental care provider, for determining plan design by a dental care provider and for recording benefit utilization by a dental care provider for a patient/participant. The system comprises one or more computers, an eligibility determining member and a service performance member. Each such computer includes at least one data storage member, at least one input member, and least one output member. Where multiple computers are utilized the computers are linked to define a network. At least one of the computers includes participant data stored on the data storage means pertaining to a participant. The eligibility determining member determining the eligibility of a participant relative to a contemplated dental procedure. The benefits utilization recordation member capable of accepting the entry by the dental care provider of information pertaining to the utilization of benefits by way of a procedure by the dental care provider.

This application is a continuation application of pending U.S. Utility patent application Ser. No. 09/288,757, filed Apr. 8, 1999.

### BACKGROUND OF THE INVENTION

1. Field of the Invention

The invention is directed to systems for use by insurance carriers, plans and dental care providers pertaining to verification of benefits, eligibility of participants and the entry and recordation of utilization of benefits, and more particularly a system which furnishes dental insurance carriers and plans with information pertaining to the eligibility of any members, and, which facilitates the entry of the utilization of benefits.

2. Background Art

Dentists (or other professionals) have had a need to determine the insurance coverage and benefits of patients that they treat. Generally, to accurately establish the effective date and type of insurance coverage of a patient (or participant), a dentist's office is required to contact a carrier or plan. Often times, these telephone calls are exceedingly time consuming. Moreover, the telephone call is verbal and does not include a written record. Thus, it is often possible to have a miscommunication and a misunderstanding between the dentist's office and the insurance carrier.

In other situations, the dentist may rely on information which is provided on the insurance card (or other insurance identification) or list sent by a carrier or plan of the patient/participant or on other information in the dentist's files. With frequent changes in coverage, abbreviated or outdated instructions on the card and outdated information in the dentist's files, reliance on information that is in the dentist's immediate possession can often prove erroneous. Thus, not only is the patient not properly charged, but additional costs are incurred and additional time is lost by both the dentist's office and the insurance carrier to correct the problem.

In addition, dental professionals must currently proceed through excessively form intensive and laborious procedures to notify insurance companies/providers of the utilization of benefits by patients/participants.

Thus, it is an object of the invention to provide dental professionals with the current, updated, and complete information regarding plan participation and member eligibility of a patient, as well as the plan design and patient/participant's financial obligation to the provider (copayment).

It is an additional object of the invention to minimize errors regarding charges for dental services rendered to the patients.

It is a further object of the invention to provide a world wide web interface for the care provider so as to provide information on a real time basis.

It is a further object of the invention to facilitate the capture, recordation and adjudication of the utilization of benefits by a participant/patient.

### SUMMARY OF THE INVENTION

The invention comprises a system for determining eligibility by a dental care provider for determining plan design by a dental care provider and for recording utilization of benefits by a care provider, plan design and patient/participant copayment level, if any. The system comprises at least one computer having at least one data storage means, at least one input means, and at least one output means. Each such at least one computer includes participant data stored on the data storage means pertaining to a participant. The invention further includes means associated with the at least one computer for determining eligibility of the participant and means associated with the at least one computer for recording utilization of benefits by the dental care provider.

In a preferred embodiment, the at least one computer comprises a plurality of computers being linked to define a network. In such an embodiment, the plurality of computers are linked by way of the world wide web.

In another preferred embodiment, the eligibility determining means comprises means for inputting a participant identifier; means for inputting a particular procedure necessitated by a participant; means for searching the participant data stored in the at least one data storage means for the participants identifier; and means for providing the participant's stored data pertaining to the participant identifier to the output means of the at least one computer. As such, data can be provided as to the eligibility of a participant for a particular procedure.

In another preferred embodiment, the participant identifier comprises at least one of the group consisting of: social security number, last name, first name, carrier and date of birth.

In another preferred embodiment, the means for inputting a particular procedure necessitated by a participant comprises means for inputting at least a procedure code, a tooth identification, and a tooth positional identification (where applicable).

In yet another preferred embodiment, the benefit utilization recording means comprises means for creating a utilization record. In such an embodiment, the benefit utilization recording means comprises means for accessing at least one created utilization record. In another such preferred embodiment, the utilization record includes an identification of the dental care provider, an identification of the participant, and the identification of the procedure necessitated by the participant.

In another preferred embodiment, the invention further includes means for selecting the operation of one of the verification means and the benefits utilization recording means. In another preferred embodiment, the invention further includes means for verifying access, thereby permitting only a select group of predetermined operators to utilize the system.

Preferably, the invention further includes means for updating the participant data stored on the data storage means of at least one of the computers of the system.

The invention further includes a method for providing information to dental care providers regarding a participant comprising the steps of: (a) determining eligibility of the participant; and (b) recording utilization of benefits by way of a procedure by the dental care provider. The step of determining the eligibility of the participant comprises the steps of: (a) inputting an identifier data pertaining to at least one participant as input; (b) searching for the identifier data in said participant data of a data storage means; and (c) providing output in the form of data pertaining to the eligibility of the at least one participant. The step of recording utilization of benefits comprises the steps of: (a) inputting an identifier data pertaining to at least one participant as input; and (b) inputting a preformed procedure data.

In a preferred embodiment, the method further comprises the step of: accessing the inputted performed procedure data in real time. In another preferred embodiment, the method further comprises the step of: updating at least a portion of the data pertaining to the eligibility of the at least one participant, wherein, the step of providing output of such data occurs in real time.

In yet another preferred embodiment, the step of inputting an identifier comprises the step of: inputting at least one of a social security number, a last name, a first name and a date of birth. In another preferred embodiment, the step of inputting data pertaining to a procedure comprises the step of: inputting at least one procedure code pertaining to a desired procedure. In yet another preferred embodiment, the step of inputting data pertaining to a procedure comprises the steps of: (a) inputting at least one procedure code pertaining to a desired dental procedure; (b) inputting an identification of the tooth undergoing the desired dental procedure; and (c) inputting the identification of the location of the tooth undergoing the desired dental procedure.

The invention further comprises a method for establishing a network for the administration of coverage to a dental care provider. The method comprises the steps of: (a) providing a plurality of computers; (b) linking the computers to form a network; (c) storing data pertaining to a participant and to a coverage plan pertaining to the participant; and (d) providing access to the data of the participant from at least one of the plurality of computers, to in turn, facilitate at least one of: (i) determining the eligibility of the participant for a particular procedure; and (ii) recording the utilization of participant benefits by the dental care provider to form utilization records.

In a preferred embodiment, the method further includes the step of updating the data so as to provide accurate data in real time. In another preferred embodiment, the step of linking the computers comprises the step of linking the computers by way of the world wide web.

In another preferred embodiment, the method further comprises the step of requiring a login prior to providing access to the data of the participant, to, in turn, maintain the security of the data.

In another preferred embodiment, the step of providing access further includes the step of providing access to facilitate access to completed utilization records.

### BRIEF DESCRIPTION OF THE DRAWINGS

FIG. 1 of the drawings is a schematic of the eligibility verification and utilization recordation system of the present invention; and

FIG. 2 of the drawing is a schematic representation of the network upon which the system operates.

### DETAILED DESCRIPTION OF THE INVENTION

While this invention is susceptible of embodiment in many different forms, there is shown herein in the drawings and will be described in detail a specific embodiment, with the understanding that the present disclosure is to be considered as an exemplification of the principles of the invention and is not intended to limit the invention to the embodiment illustrated.

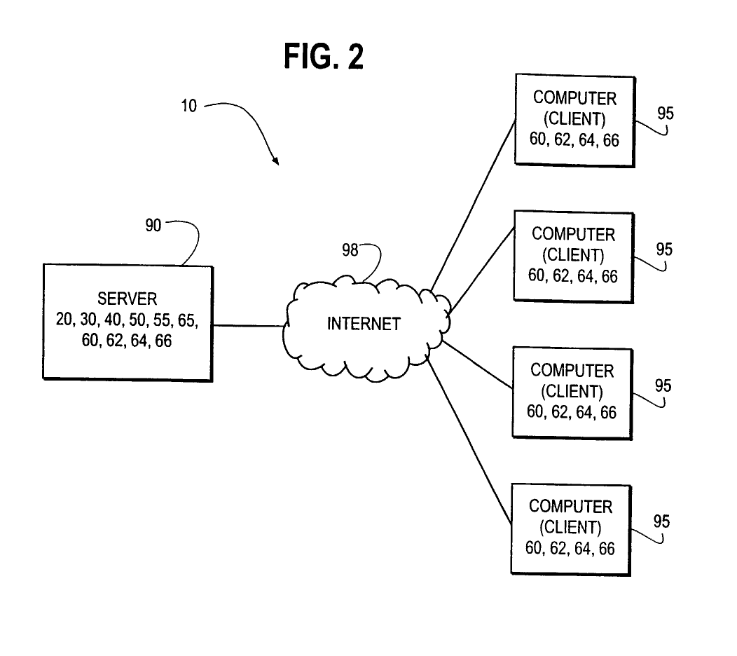

System 10 for determining eligibility by a dental care provider for determining plan design by a dental care provider and for recording utilization by a dental care provider is shown schematically, in its operating phase, in FIG. 2 of the drawings. It is preferred that system 10 is a world wide web based networked system of computers. In particular, server 90 is associated with world wide web 98, and includes a particular domain address. Thus, any other computers 95 (clients) having access to the world wide web can access the computer. Each such computer includes input means 60, output means 62, data storage 64 means and processor means 66. For example, any of the servers and clients may comprise Pentium based computers or other compatible processor based computers (such as the Celeron, Cyrix, AMD or earlier processor equipped computers), RISC based computers (such as those from Sun Microsystems) or Macintosh computers, running various operating systems (ie. Windows 95, Windows98/NT, OS2, Macintosh OS, or UNIX). Such computers will also include keyboards, mouses, tablets, NICS, modems and the like for receiving instructions; video screens, audio, modems and NICS for delivering output; and hard drives and various removable media for the storage of data.

It will be understood that the system is however not limited to interfacing through the world wide web, and, instead the system may comprise a single computer having the information therewithin or available in disk or CD-ROM form, or the system may comprise several computers which are connected so as to form an intranet via a LAN or WAN. In sum, while the invention will be described in a server/client environment wherein communication is maintained over the world wide web, the invention is not limited to a particular quantity of computers and the particular configuration of the communication interface between computers.

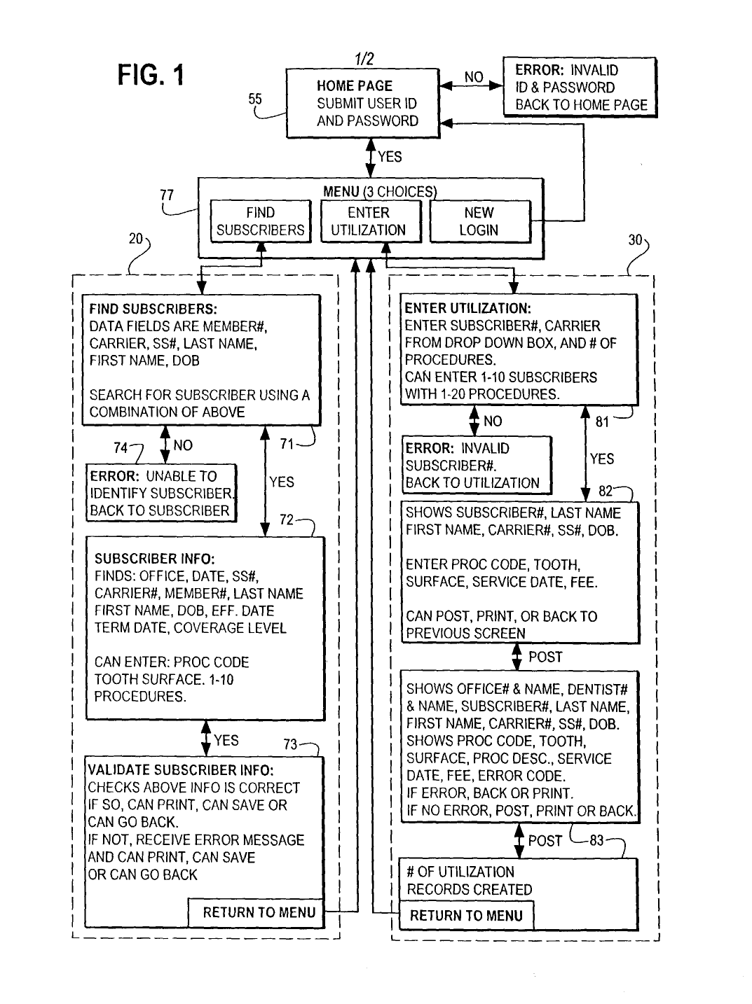

The server and/or client in such a system includes a software package, as shown in FIGS. 1 and 2, which includes means 20 (FIG. 1) for identifying eligibility of participant subscribers, means 30 (FIG. 1) for recording utilization for patient, means 40 for updating the system, means 50 for accessing the utilization information and means 65 for tracking use of the system. In this embodiment, the software package is in server 90 and clients 95 utilize a web browser such as Netscape Navigator or Microsoft Internet Explorer. To access these means from the client computer, the operator is first prompted by verification means 55 to login by way of entering a user ID and a password. Once entered and accepted, the user can proceed to utilize the appropriate desired features identified below. By using such a restricted access procedure through verification means 55, the system can not only limit the information to the subscribers of the system, but can also be tailored so as to provide different information to different users and different types of users. For example, certain users can access the update means. A different set of users may have access to the participant eligibility determining means. Among the set of users that have access to the participant eligibility means, certain ones may have access to different aspects thereof.

Participant eligibility determining means 20 essentially comprises a machine programmable software package which performs the following functions and operations: providing information pertaining to a participant/patient that is covered by a carrier, and providing information pertaining to the participant as it relates to a particular contemplated dental procedure. Various means within the eligibility means perform these functions.

The operation of the eligibility determining means is initiated by an operator requesting information pertaining to a subscriber or individual that is to obtain treatment from the dental care provider. As shown in FIG. 1, as first step 71 the user first enters any one or more of the following: an insurance member number; a carrier identification; last name; first name; date of birth; social security number of other means of identification. Once entered, a software search of participant data files on server 90 is undertaken to find a match. If no match is found, the operator is alerted by the system, through alert step 74, that no information is available for the subscriber. In such a situation, the operator is advised that the individual may not have dental insurance coverage, and that the individual is therefore personally responsible for payment of the services.

On the other hand, if the participant identification is found within the participant data files, the operator is provided with information through step 72 pertaining to the subscriber. Such information can include, but is not limited to, the social security number of the individual, the first and last name of the individual, the date of birth of the individual, the member number of the individual, the carrier number of the insurance carrier of the individual, the effective date of coverage, the term of coverage dates, the coverage levels for the individual and the assigned dental care provider if it is a provider network based plan. Inasmuch as the operator has logged onto the system through verification means 55, and the system is aware of the particular operator that is requesting the information, the information provided by the system can be tailored to the predetermined and known needs or preferences for that particular operator. For example, where the dental care operator or provider, comprises an oral surgeon, the system can be tailored so as to disclose the coverage of the individual for only those services which the oral surgeon performs. Thus, the operator will not be flooded with information from the participant data that is not required.

As shown in FIG. 1, once the information is received, the operator can enter the requested or the desired procedure that is to be done by the dental care provider, by way of step 75. (In the contemplated dental environment, the operator can enter any number of procedures up to ten procedures). For each procedure, the operator enters the procedure code (a set of procedure codes can be made available on a separate screen, a pulldown menu or in a user manual), the tooth identification number and the surface of the tooth that is treated, if applicable. It will be understood that while the software in this embodiment can accept ten procedures at once, different embodiments may accept a greater or fewer number of procedures. In addition, in different dental environments, the information that the operator enters regarding the particular procedures that are to be undertaken may be different and suited to that particular environment. Moreover, the particular input sequence is not limited to that disclosed. Rather, any input sequence which identifies to the system with particularity the dental procedure that is to be done, may be utilized.

Once the information is entered, the system can respond to the operator, by way of step 73 (FIG. 1), by validating the subscriber information and the input procedure information. For example, the operator can be told that the information is correct, then the operator can print the information or save it electronically on the computer. If the system determines that the information provided by the operator is not in order, the system issues an error, and then the operator can review the information and make corrections where required. If a problem persists, the operator can print the error messages for later error correction or clarification. As such, if the information is incorrect, the operator can proceed to other tasks, and can leave the problematic entries or tasks for later solution. Indeed, even if a telephone call to the carrier is required for these problematic entries, the total time saved by the direct determination still results in considerable savings.

As the user completes the eligibility determination for each patient or individual, the user can prompt the system to receive new subscriber information through the eligibility determination means. Alternatively, the user can exit the system. This may all be by way of menu step 77 (FIG. 1).

Benefits utilization means 30 comprises a set of software instructions which, like the identification means, may be accessed by an operator after logging into the system. Indeed, as explained above, once logged in, the user is capable of accessing the benefits utilization means to the extent permitted by the administration of the system.

The utilization means, as shown in FIG. 1, comprises software which is initiated by step 81, by requesting subscriber information (such as the subscriber number), the particular carrier for the participant and the number of dental procedures that have been completed by the dental care provider to the participant. Once this information is entered, by way of step 82, the system verifies the subscriber number of the participant and returns to the user information pertaining to the participant, such as the social security number, the first and last names, the carrier number and the date of birth so that the operator can verify that the correct participant has been selected by the system. Once the operator verifies this information, also by way of step 82, the operator enters the particular medical procedures into the system which were performed by the dental care provider. Procedure related information for an embodiment of the invention pertaining to the dental environment, may comprise the procedure code (as explained above the procedure code can be provided by the system in, for example, a pull-down menu, or by documentation associated with the system), the tooth that required the procedure, the surface of the tooth that required the procedure, the service date and the fee that was charged.

Once the information is complete for each procedure, the operator, through steps 82 and 83, can post the information. In particular, the posting of the information transmits the information to the system, and in turn, with this information the system can create a utilization record 83 which will include, but not be limited to, the following information: dental care provider number and name, the dentist number and name (this information can be obtained from the user login), the subscriber number and full name, the carrier number, the social security number of the subscriber, the date of birth of the subscriber, the procedure code, tooth, surface, procedure description, service date and fee for each procedure that was entered by the operator for the subscriber. In addition, if any errors are identified by the system, such errors can likewise be identified on the utilization record.

As shown in FIG. 2, by using access means 40 which is another segment of the system, the dental care carriers from client 95 or from server 90, and others who require the utilization records can likewise login to the system and obtain the utilization records pertaining to subscribers that belong or that are carried by the carrier or the plan. For example, the utilization records may be utilized by the carriers with the plan to direct benefits payments to the dental care providers. The utilization records available to a particular carrier through the access means may be limited by the login/password procedure.

Means 50 for updating the system as shown in FIG. 2, is a segment of the system which is accessed by administrators of the system through a client 95 or directly through server 90. The updating means provides the capability to update information pertaining to the identification of the subscribers, the identification of the carriers, the identification of the effective date of coverage, the term of coverage and the level of coverage for any subscriber. This information may be updated by a specific administrator of the system. In addition, it is likewise contemplated that the system may be updated by individual carriers or plans who are given access to the updating means. For example, it is contemplated that each carrier can access to the updating means of the system, and can transmit to the system any changes in information pertaining to their participants as soon as such changes are implemented by the carrier. Thus, the updating means operates on a 24 hour basis, and permits continuous updating of the data stored in the system. As a result, throughout the operation of the system, the operator is provided with accurate, dependable information pertaining to a subscriber on a real-time basis.

The system includes means 65 for tracking the use and access of the system by carriers and dental care plans. For example, the tracking means may comprise a subscription based system wherein the carriers and plans pay a flat fee or a per patient fee to subscribe to and to have access to the system. Thus, a means is provided for the generation of income by the administrator of the system.

In sum, through the use of the above-described system, the participating dental care provider is given an apparatus and a method for determining the eligibility of subscribers (even in DHMO type plans), determining the overall success in operation of design of the plan, and determining the participant's benefits including patient co-payments. Thus, the patients can more easily obtain appropriate dental services and errors in billing and co-payment can be minimized. In addition, since the information is continuously updated, the information received by the system operator at the dental care provider comprises accurate and up to the minute information. Thus, the invention places this information, in real time, which has been previously available to the dental care provider only through a telephone call with the carrier, at the immediate computer access of the operator, as long as the operator has access to the world wide web and the appropriate login information.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

What is claimed is:

1. A system for determining eligibility of a participant with respect to particular procedures performable by a dental care provider comprising:
a first computer and a second computer, at least one of said first and second computers having at least one data storage means, at least one input means and at least one output means,
participant data pertaining to said participant remotely stored in at least one database on said data storage means of said first computer,
means associated with at least said second computer for determining eligibility of said participant in real time;
said input means being associated with said second computer for inputting a particular procedure and formulating a query regarding eligibility of said participant to said participant data stored on said data storage means of said
first computer in real time and cooperating with said means for determining eligibility so as to provide a reply to said eligibility query to said dental care provider in real time; and,
means associated with said first or second computer for recording utilization of benefits by the dental care provider in real time.

2. The system according to claim 1 wherein said system further comprises said first and second computers being linked to form a network.

3. The system of claim 1 wherein said first and second computers are linked by way of the world wide web.

4. The system of claim 1 wherein the eligibility determination means provides said reply to said eligibility query to said provider prior to said provider performing said procedure.

5. The system of claim 1 further including means for updating the participant data stored on the data storage means.

6. A method of providing information to dental care providers regarding the insurance eligibility of a participant for a dental procedure with respect to at least one insurance carrier comprising the steps of:
determining eligibility of said participant comprising the steps of:
inputting a query regarding eligibility of said participant containing identifier data pertaining to said participant with respect to a plurality of insurance carriers on a first computer;
sending said query to at least one database having data of said plurality of insurance carriers regarding the participant stored therein and located at least in part on data storage means remote from said first computer;
searching for the participant data responsive to said eligibility query in said participant data of said at least one database;
providing output in the form of a response to said eligibility query in real time pertaining to the eligibility of said participant;
inputting a procedure code as a query in real time to said at least one database to determine whether said procedure is covered by said participant's plan prior to performing said procedure; and
receiving a response to said query in real time from said at least one database.

7. The method of claim 6 further including the steps of:
recording the utilization of benefits and claims in real time by way of said procedure by said dental care provider comprising the steps of:
inputting an identifier data pertaining to said participant; and,
inputting a performed procedure data.

8. The method of claim 6 further including the steps of updating the data so as to provide accurate data in real time.

9. A system for determining eligibility of a participant for particular dental procedures by a dental care provider with respect to at least one insurance carrier comprising:
at least one computer having at least one input means and at least one output means,
remote data storage means accessible by said at least one computer and containing at least one database comprising data pertaining to said participant stored thereon with respect to multiple insurance carriers;
means associated with said at least one computer for determining eligibility of said participant in real time;
said input means being associated with said at least one computer for inputting said particular procedure and formulating a query regarding eligibility of said participant to said at least one remote database in real time and cooperating with said means for determining eligibility so as to provide a reply to said eligibility query from said remote database to said provider in real time without the need to pre-register the participant with said provider and without sending said participant's data to said provider in advance of the eligibility query; and
means associated with said at least one computer for recording utilization of benefits by said dental care provider in real time.

10. The invention according to claim 9 wherein said means for determining eligibility of a particular participant can be accessed by a plurality of providers at the same time.

11. A method of providing information to dental care providers regarding the insurance eligibility and benefits of a participant with respect to at least one insurance carrier comprising the steps of:
determining eligibility of said participant in real time comprising the steps of:
inputting a query regarding eligibility of said participant containing identifier data pertaining to said participant;
sending said query in real time to at least one remote database having data of said plurality of insurance carriers regarding said participant stored therein;
searching for said participant data responsive to said eligibility query in said at least one remote database;
providing output in the form of a response to said eligibility query in real time pertaining to said eligibility of said participant;
inputting a procedure code in real time to determine whether the procedure is covered by said insurance carrier prior to performing the procedure; and
receiving a response to said inputting of said procedure code in real time as to whether the procedure is covered by said insurance carrier.

12. The method of claim 11 further comprising the steps of:
recording the utilization of benefits and claims in real time by way of a procedure by said dental care provider comprising the steps of:
inputting an identifier data pertaining to said participant; and,
inputting a performed procedure data.

13. A system for determining eligibility of a participant with respect to the plan of a plurality of insurance carrier with respect to particular procedures performable by a dental care provider comprising:
at least one computer, said computer having at least one input means and at least one output means;
a data storage means operably associated with a first computer of said at least one computer;
data pertaining to said participant with respect to said plurality of carriers stored in a database stored on said data storage means, said database being located remote from said first computer;
means associated with said at least one computer for determining eligibility of said participant in real time, by both requesting information and receiving a response thereto regarding the eligibility of said participant from said remote database in real time, such that multiple providers can access said data of said participant simultaneously;
wherein said provider can obtain customized participant data and can request additional participant data in real time;
said input means is associated with said at least one computer for inputting a particular procedure in order to determine eligibility for said procedure prior to providing said procedure without the need to download said participant's data from said remote database to said computer in advance of said determination and regardless of whether the participant is pre-registered with said provider; and
means associated with said at least one computer for recording utilization of benefits by said dental provider in real time.

14. A method of providing information to dental care providers regarding a participant of an insurance plan with respect to at least one insurance carrier comprising the steps of:
determining eligibility of said participant by both requesting participant data in real time and receiving a response to said request in real time comprising the steps of:
having one of said dental care providers input identifier data pertaining to said participant on a first computer in the form of a request to at least one database containing participant data with respect to said at least one insurance carrier, at least a portion of said participant data being stored remotely from said first computer;
searching for the identifier data in said participant data of said at least one remote database;
providing output as a response to said request to said dental care provider in the form of customized participant data provided in real time pertaining to the eligibility of said participant from said remote database without the need to download said participant's data from said database to said first computer in advance of said determination and regardless of whether the participant is pre-registered with said provider;
inputting a procedure code to determine in real time whether the procedure is covered by the participant's plan prior to performing the procedure; and
recording the utilization of benefits and claims in real time by way of a procedure by the dental care provider comprising the steps of:
inputting an identifier data pertaining to said participant; and,
inputting a performed procedure data.
